(19) United States
(12) Patent Application Publication
(10) Pub. No.: US 2020/0093130 A1
(43) Pub. Date: Mar. 26, 2020

(54) APPLICATION OF TETRAHYDROBENZAZOLE IN PREPARATION OF AGRICULTURAL FUNGICIDE OR FUNGICIDE COMPOSITION AND PREPARATION METHOD THEREOF

(71) Applicant: JIANGSU FREY AGROCHEMICALS CO., LTD, JIANGSU (CN)

(72) Inventors: Kangping YU, JIANGSU (CN); Nan LI, JIANGSU (CN); Jie JIA, JIANGSU (CN); Hongwei BAI, JIANGSU (CN)

(21) Appl. No.: 16/619,107

(22) PCT Filed: Dec. 6, 2017
(86) PCT No.: PCT/CN2017/114788

§ 371 Date: Dec. 4, 2019

(30) Foreign Application Priority Data
Jun. 5, 2017 (CN) 201710417611.X

(51) Int. Cl. A01N 43/653; A01N 25/12; A01N 25/04

(52) U.S. Cl. CPC A01N 43/653; A01N 25/04; A01N 25/12

(57) ABSTRACT

An application of tetrahydrobenzazole in the preparation of an agricultural fungicide or a fungicide composition and a preparation method therefor. A 4-((-(2-chloro-4-(4-chlorophenoxy)phenyl)-4-methyl-1,3-dioxapentan-2-yl)methyl)-4H-1,2,4-triazole(tetrahydrobenzazole) compound has application in agricultural fungicides, having the structural formula shown in formula I is provided. Also, the embodiments transform waste that can usually only be treated as a hazardous organic waste solid, accounting for 35-40% of the production process of an agricultural fungicide difenoconazole, into a useful pesticide, significantly reducing discharge of hazardous organic waste solids, and alleviating environmental protection pressure on manufacturers. The preparation method of the embodiments can also increase the yield of difenoconazole and reduce costs.

### CROSS-REFERENCE TO RELATED APPLICATIONS

This application claims priority to PCT Application No. PCT/CN2017/114788, having a filing date of Dec. 6, 2017, which is based on CN Application No. 201710417611.X, having a filing date of Jun. 5, 2017, the entire contents both of which are hereby incorporated by reference.

### FIELD OF TECHNOLOGY

The following pertains to the field of agricultural fungicides, specifically to an application of 4-((-(2-chloro-4-(4-chlorophenoxy)phenyl)-4-methyl-1,3-dioxapentan-2-yl) methyl)-4H-1,2,4-triazole (tetrahydrobenzazole) compound shown in Formula I in the preparation of agricultural fungicide or fungicide composition and a preparation method thereof.

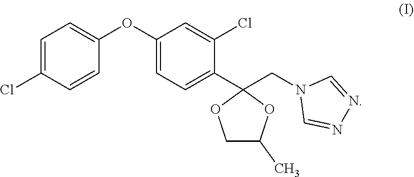 [SMILES: CC1COC(Cn2cnnc2)(c2ccc(Oc3ccc(Cl)cc3)cc2Cl)O1]

### BACKGROUND

1-((2-(2-chloro-4-(4-chlorophenoxy) phenyl)-4-methyl-1,3-dioxapentan-2-yl) methyl)-1H-1,2,4-triazole (difenoconazole) is an ideal triazole type agricultural fungicide. As reported by W. Ruess et al, it is systemic, an inhibitor to demethylation of sterol, has a wide fungicide spectrum, can raise crop yield and assure quality through leaf treatment or seed treatment, shows a persistent protective and therapeutic activity against Ascomycetes, Basidimycetes, fungi imperfecti including Alternaria, Ascochyta, Cercospora, Colletotrichum, Guignardia, Phoma, Ramularia and Venturia, Erysiphe, Uredinales and some pathogens and has a special effect on grape powdery mildew, peanut leaf spot, net blotch, potato early blight, wheat blight, leaf blight, rust, sugar beet brown spot, etc.

The application documents of British patent GB2098607 (1982), European patent EP0065485A2 (1982) and US patent U.S. Pat. No. 5,266,585 (1993) have disclosed synthetic methods and applications of difenoconazole series compounds.

Chinese patents CN1631888A (2005), CN101323612A (2008), CN101560205 (2009), CN 101899040 (2010), CN101781290A (2010), CN102060850 (2011), CN102250072 (2011), CN102432600A (2012), CN103360372 (2013) and CN102898422 (2013) are all about methods for synthesis and refinement of difenoconazole. These methods mainly describe and set requirements for how to synthesize difenoconazole, raise the synthesis yield of difenoconazole and purify difenoconazole, but they do not introduce and report the treatment of 4-((-2-chloro-4-(4-chlorophenoxy) phenyl)-4-methyl-1,3-dioxapentan-2-yl) methyl)-4H-1,2,4-triazole (tetrahydrobenzazole) compound shown in Formula 1 generated in the synthesis process.

### SUMMARY

An aspect relates to a new use of such 4-((-(2-chloro-4-(4-chlorophenoxy) phenyl)-4-methyl-1,3-dioxapentan-2-yl) methyl-4H-1,2,4-triazole (tetrahydrobenzazole) compounds: application of 4-((-(2-chloro-4-(4-chlorophenoxy) phenyl)-4-methyl-1,3-dioxapentan-2-yl) methyl)-4H-1,2,4-triazole (tetrahydrobenzazole) in preparation of agricultural fungicide or fungicide composition. The embodiments of the present invention turn the waste that accounts for 35˜40% and can be disposed as hazardous organic solid waste only during production of agricultural fungicide difenoconazole into a useful pesticide, significantly reducing discharge of hazardous organic waste solids and alleviating environmental protection pressure on manufacturers.

Another aspect of the present invention is to provide a method for preparing 4-((-(2-chloro-4-(4-chlorophenoxy) phenyl)-4-methyl-1,3-dioxapentan-2-yl) methyl)-4H-1,2,4-triazole (tetrahydrobenzazole) compound, which can raise the yield of difenoconazole and reduce cost.

The following technical solution is adopted to fulfill aspects of the present application:

Application of 4-((-(2-chloro-4-(4-chlorophenoxy) phenyl)-4-methyl-1,3-dioxapentan-2-yl) methyl)-4H-1,2,4-triazole (tetrahydrobenzazole) compound in agricultural fungicides, of which structural formula is as shown in I:

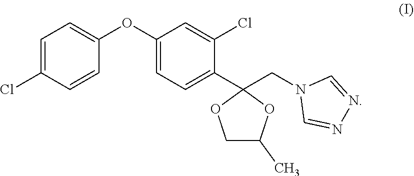 [SMILES: CC1COC(Cn2cnnc2)(c2ccc(Oc3ccc(Cl)cc3)cc2Cl)O1]

The 4-((-(2-chloro-4-(4-chlorophenoxy) phenyl)-4-methyl-1,3-dioxapentan-2-yl) methyl)-4H-1,2,4-triazole (tetrahydrobenzazole) compound provided by the embodiments of the present invention has very high biological activity, can prevent and treat various diseases caused by Ascomycetes, Basidimycetes, fungi imperfecti including Alternaria, Ascochyta, Cercospora, Colletotrichum, Guignardia, Phoma, Ramularia and Venturia, Erysiphe, Uredinales and some pathogens, and shows a persistent protective and therapeutic activity against potato early blight, rice sheath blight disease, watermelon anthracnose, pear scab, banana leaf spot, powdery mildew of cucumber, etc. at a very low dose. Therefore, the embodiments of the present invention includes application of a compound in Formula I as a fungicide in agriculture and other fields.

Meanwhile, the compound shown in Formula I has low toxicity to insects beneficial to environment, mammals, birds and fish and no toxicity to plants.

Owing to the positive features, the compound shown in Formula I can be used to protect main crops in agriculture and horticulture from damage by harmful germs. The compound at a dose of 5-500 grams per hectare is able to provide effective prevention and treatment. An optimized dose of the compound is 100-300 grams per hectare.

For more effective application in agriculture, typically it is helpful to mix the compound in Formula I with one or more agriculturally acceptable carriers to form a composition.

Therefore, another technical solution of the embodiments of the present invention further includes a fungicide composition, containing the compound in Formula I as an active ingredient and agriculturally acceptable carriers. In the composition, the weight percentage of the active ingredient is 1%˜99%.

The application is to mix the compound with one or more other fungicides, insecticides, herbicides or plant growth regulators to form a binary or ternary mixed formulation.

A use form of the composition can be liquid or solid such as granules, suspension concentrate or emulsifiable concentrate. The type of the composition is subject to the needs of specific applications.

Specific methods for preparation of a few dosage forms of the composition are illustrated below as examples:

Preparation of granules: Mix the active ingredient, various surface active agents, solid diluents (e.g., starch, clay and silicate) and other components as per requirements of the formula, pulverize them in an ultrafine grinder, and extrude and pelletize the powder to obtain a granular product with a predetermined content (e.g., 10%˜80%).

Preparation of suspension concentrate: In a commonly used formula, the content of the active ingredient is 10%˜40%. Water or white wax is used as a medium, and the active ingredient, dispersing agent, suspending agent and antifreezing agent are added into a grinder and ground to obtain suspension concentrate.

Preparation of emulsifiable concentrate: Add the active ingredient, surface active agents and solvent into a preparation kettle as per requirements of the formula and stir and mix them well to obtain an emulsifiable concentrate product.

The embodiments of the present invention provide a tetrahydrobenzazole compound in Formula I, which is able to effectively control harmful pathogens at a very dose, and is apt to popularization and application in agriculture.

In order to alleviate environmental pressure of difenoconazole manufacturers, raise difenoconazole yield and reduce production cost, in-depth research was conducted on waste generated from refinement of difenoconazole. The following technical solution is adopted to fulfill a second invention mission of the present application: a method for preparing the foregoing 4-((-(2-chloro-4-(4-chlorophenoxy) phenyl)-4-methyl-1,3-dioxapentan-2-yl) methyl)-4H-1,2,4-triazole (tetrahydrobenzazole), comprising the following steps:
(1). Adding difenoconazole waste into a reactor and dissolve it in a solvent;
(2). Salifying it with an acid at appropriate temperature and crystallizing upon cooling;
(3). Performing filtration and separation at appropriate temperature to obtain tetrahydrobenzazole salt;
(4). Adding separated filtrate into the reactor again, salifying it with an acid again and crystallizing upon cooling;
(5). Performing filtration and separation to obtain tetrahydrobenzazole salt, recovering the solvent from the separated filtrate through treatment and distillation for reuse, and disposing residue after distillation as a solid waste;
(6). Adding difenoconazole salt obtained at step (5) into the reactor, adding an appropriate amount of toluene and water, decomposing in alkali at appropriate temperature, and resting for phase split;
(7). Separating the water phase in the lower layer, washing the toluene phase in the upper layer with water until the toluene phase is neutral and thoroughly removing water;
(8). Conducting reduced pressure distillation to recover toluene for reuse, with remnant being difenoconazole crude oil;
(9). Obtaining difenoconazole technical through further refinement to raise total yield of difenoconazole and reduce production cost;
(10). Adding tetrahydrobenzazole salt obtained at step (3) into a reactor, adding a specific amount of toluene and water, decomposing in alkali at specified temperature and resting for phase split;
(11). Separating the water phase in the lower layer, washing the toluene phase in the upper layer with water until it is neutral and thoroughly removing water;
(12). Conducting reduced pressure distillation to recover toluene for reuse, with remnant being difenoconazole crude oil;
(13). Adding tetrahydrobenzazole crude oil obtained at step (12) to a refining reactor, adding an equal amount of toluene, raising temperature for dissolution, cooling and crystallizing under stirring, then performing filtration and separation to obtain tetrahydrobenzazole technical, distilling the filtrate after filtration and separation to recover toluene for reuse, and disposing remnant in a centralized manner.

At the foregoing step (1), the solvent is alkanes (e.g., hexane and cyclohexane), arenes (e.g., benzene, toluene and xylene), alcohols (e.g., methanol, ethanol, propanol and isopropanol) or ethers (e.g., diethyl ether, isopropyl ether and methyl tert-butyl ether), preferably toluene or isopropanol; a dose of the solvent is 1˜10 times, preferably 3˜4 times of the weight of difenoconazole waste; the appropriate temperature at step (2) is 10˜60° C., preferably 20˜40° C.; the acid is hydrochloric acid (including hydrogen chloride gas), nitric acid, sulfuric acid and hydrogen bromide, preferably nitric acid; a dose of nitric acid (a dose of nitric acid at the first time) is 1˜2 times, preferably 1˜1.2 times, of the mole number of tetrahydrobenzazole in difenoconazole waste; mass concentration of nitric acid is 65˜100%, preferably 95˜98%;

The appropriate temperature for filtration and separation at step (3) is 0˜25° C., preferably 15˜18° C.;

The acid at step (4) is hydrochloric acid (including hydrogen chloride gas), nitric acid, sulfuric acid and hydrogen bromide, preferably nitric acid; a dose of nitric acid (a dose of nitric acid at the second time) is 1˜2 times, preferably 1˜1.2 times, of the mole number of difenoconazole in difenoconazole waste; mass concentration of nitric acid is 65˜100%, preferably 95˜98%;

The alkali at step (6) typically is sodium hydroxide (m/m30% caustic soda liquid), potassium hydroxide, sodium carbonate, potassium carbonate or ammonium hydroxide, etc., preferably m/m30% caustic soda liquid; a dose is 1˜2 times, typically 1˜1.1 times of the mole number of difenoconazole nitrate; appropriate decomposition temperature is 10˜70° C.; a dose of toluene is 1˜10 times, preferably 3˜4 times, of the weight of difenoconazole nitrate;

The alkali at step (10) typically is sodium hydroxide (m/m30% caustic soda liquid), potassium hydroxide, sodium carbonate, potassium carbonate or ammonium hydroxide, etc., preferably m/m30% caustic soda liquid; a dose is 1˜2 times, typically 1˜1.1 times of the mole number of difenoconazole nitrate; appropriate decomposition temperature is 10˜70° C.; a dose of toluene is 1˜10 times, preferably 3˜4 times, of the weight of difenoconazole nitrate;

It is well-known to those skilled in the art that in a process of synthesis of agricultural fungicide difenoconazole, two compounds will be generated, one is 1-((2-(2-chloro-4-(4-chlorophenoxy) phenyl)-4-methyl-1,3-dioxapentan-2-yl) methyl)-1H-1,2,4-triazole (difenoconazole), accounting for 75˜80% of the total amount; and the other is 4-((-(2-chloro-4-(4-chlorophenoxy) phenyl)-4-methyl-1,3-dioxapentan-2-yl) methyl)-4H-1,2,4-triazole (tetrahydrobenzazole), accounting for 13˜18% of the total amount.

Difenoconazole is a triazole fungicide currently widely used in agriculture. As reported by W. Ruess et al, it is systemic, an inhibitor to demethylation of sterol, has a wide fungicide spectrum, can raise crop yield and assure quality through leaf treatment or seed treatment, shows a persistent protective and therapeutic activity against Ascomycetes, Basidimycetes, fungi imperfecti including Alternaria, Ascochyta, Cercospora, Colletotrichum, Guignardia, Phoma, Ramularia and Venturia, Erysiphe, Uredinales and some pathogens and has a special effect on grape powdery mildew, peanut leaf spot, net blotch, potato early blight, wheat blight, leaf blight, rust, sugar beet brown spot.

As for the other compound tetrahydrobenzazole, those skilled in the art have done some research and reported only on how to reduce the generation of tetrahydrobenzazole and raise the synthetic yield of difenoconazole in a synthetic process, and have not done in-depth research on preparation and purification methods and bioactivity of tetrahydrobenzazole. Currently, domestic difenoconazole technical manufacturers can achieve difenoconazole yield of 60˜65% through refinement after synthesis, with generation of 35˜40% waste, which has to be disposed as a hazardous solid waste as no good treatment method is available, causing significant environmental protection pressure on the manufacturers.

The embodiments turn the waste that accounts for 35˜40% and can be disposed as a hazardous organic solid waste only during production of agricultural fungicide difenoconazole into a useful pesticide, significantly reducing discharge of hazardous organic waste solids and alleviating environmental protection pressure on manufacturers. The preparation method according to embodiments of the present invention can also raise the yield of difenoconazole and reduce cost.

### DETAILED DESCRIPTION

Below specific embodiments will be used to further describe embodiments of the present invention, but the present invention is not limited to these embodiments.

### Embodiment 1

Step 1,

Reaction Equation:

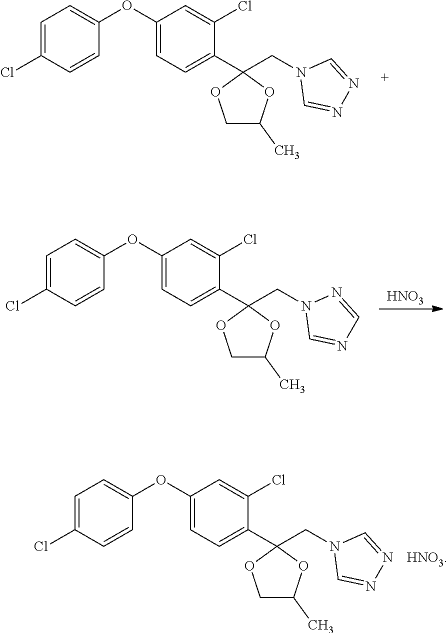

Add 1000 kg of difenoconazole waste (difenoconazole content 36.7%, 0.903 kmol, and tetrahydrobenzazole content 33.8%, 0.832 kmol) into a 5000 L reactor, pump 3000 kg of toluene into the reactor, raise temperature to about 30° C. under stirring, stir for 1 h and confirm thorough dissolution; then dropwise add 59 kg of nitric acid (content 98%, 0.915 kmol) put in an elevated tank in advance into the reactor, cool the jacket of the reactor with water to control temperature within 40° C. during the addition of nitric acid, stir for a half hour after completion of the addition, then cool and crystallize, slowly cool to 17° C. in 4 h, stir and hold temperature at about 17° C. for 1 h, then filter the reaction solution through a filter press, transfer the filtrate to another 5000 L reactor, with the filter cakes being 420 kg of a wet tetrahydrobenzazole nitrate product, take a sample and conduct analysis (gas chromatography area normalization method), tetrahydrobenzazole 95.8% and difenoconazole 3.7%.

Step 2;

Reaction Equation:

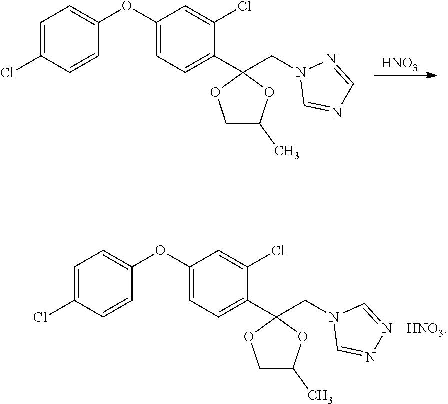

Raise temperature of the filtrate in another 5000 L reactor to about 30° C. under stirring, dropwise add 63.5 kg of nitric acid (content 98%, 0.99 kmol) put in an elevated tank in advance into the reactor after temperature is constant, cool the jacket of the reactor with water to control temperature within 40° C. during the addition of nitric acid, stir for a half hour after completion of the addition, then cool and crystallize, slowly cool to 15° C. in 4 h, stir and hold temperature at about 15° C. for 1 h, then filter the reaction solution through a filter press, transfer the filtrate to another 4000 L reactor, with the filter cakes being 450 kg of a wet difenoconazole nitrate product, take a sample and conduct analysis (gas chromatography area normalization method), tetrahydrobenzazole 5.5%, difenoconazole 93.3%.

Add 400 kg of water and an appropriate amount of 30% sodium hydroxide water solution into the filtrate in another 4000 L reactor under stirring, adjust pH value to 8˜9, then raise temperature to about 60° C., stop stirring, rest for layering, separate the water phase in the lower layer, wash the organic phase in the upper layer with 400 kg/time of water until the organic phase is neutral, thoroughly remove water, raise temperature under stirring, conduct reduce pressure distillation at a vacuum degree of about −0.09 Mpa, use removed toluene cyclically, stop the distillation, vacuumizing and stirring when temperature inside the reactor reaches about 120° C., put remnant in the reactor into barrels while it is hot, weigh it (350 kg) and dispose it as a solid waste.

Step 3:

Reaction Equation:

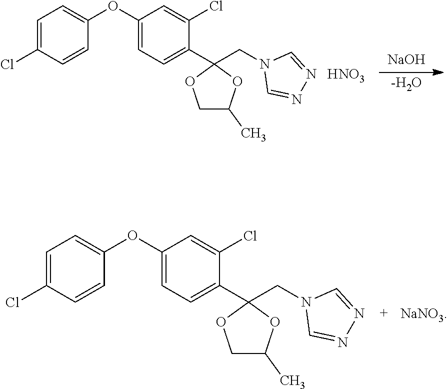

Add 450 kg of the wet difenoconazole nitrate product obtained at step (2) into a 2000 L reactor, add 1200 kg of toluene and 120 kg of 30% sodium hydroxide water solution, adjust pH value to 8˜9, raise temperature to about 60° C. under stirring, stop stirring and heating, rest for layering, separate the water phase in the lower layer, wash the organic phase in the upper layer with 400 kg/time of water again until the organic phase is neutral, thoroughly remove water, raise temperature under stirring, conduct reduce pressure distillation at a vacuum degree of about −0.09 Mpa, use removed toluene cyclically, stop the distillation, vacuumizing and stirring when temperature inside the reactor reaches about 120° C., put difenoconazole crude oil in the reactor into barrels while it is hot, weigh it (337.5 kg), take a sample and conduct analysis (liquid chromatography quantitative method). The content of difenoconazole is 92.1% and the recovery rate is 84.7% (a method for further refining difenoconazole crude oil to obtain technical is not introduced further herein).

Step 4:

Reaction Equation:

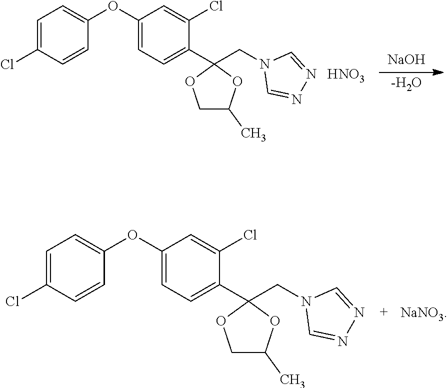

Add 420 kg of the wet tetrahydrobenzazole nitrate product obtained at step (1) into a 2000 L reactor, add 1200 kg of toluene and 110 kg of 30% sodium hydroxide water solution, adjust pH value to 8˜9, raise temperature to about 60° C. under stirring, stop stirring and heating, rest for layering, separate the water phase in the lower layer, wash the organic phase in the upper layer with 400 kg/time of water again until the organic phase is neutral, thoroughly remove water, raise temperature under stirring, conduct reduce pressure distillation at a vacuum degree of about −0.09 Mpa, use removed toluene cyclically, stop the distillation, vacuumizing and stirring when temperature inside the reactor reaches about 120° C., weigh tetrahydrobenzazole crude oil in the reactor while it is hot (315 kg), take a sample and conduct analysis (liquid chromatography quantitative method). The content of tetrahydrobenzazole is 94.2% and the recovery rate is 87.8%.

Step 5:

Add 315 kg of tetrahydrobenzazole obtained at step (4) into a 1000 L reactor while it is hot, add 315 kg of toluene, raise temperature under stirring until backflow, fully dissolve tetrahydrobenzazole in toluene, then slowly cool and crystallize, reduce temperature to room temperature 25° C., stir and hold temperature for 1 h, filter by filter press, press filtrate to another 1000 L distillation still to recover toluene for cyclic use (the residual liquid is treated in a centralized manner. The treatment is not described herein), and dry off the filter cakes to obtain 278.5 kg of tetrahydrobenzazole technical (content (quantitative analysis by liquid chromatography): 98.5%, recovery rate of refinement: 92.4%, and melting point: 102˜104° C.).

### Embodiment 2

10% compound I (tetrahydrobenzazole) granules:

| | |
|---|---|
| Compound I | 10%; |
| Dispersing agent 890 | 68%; |
| Dispersing agent CP86 | 3%; |
| Humectant SW | 1%; |
| Defoaming agent | 0.2%; |
| Sodium sulfate | 5%; |

Top up with light calcium carbonate to 100%.

After all the components are fully mixed, they are pulverized in an ultrafine grinder and extruded, pelletized and dried to obtain 10% granules.

### Embodiment 3

30% compound I (tetrahydrobenzazole) suspension concentrate.

| | |
|---|---|
| Compound I | 30%; |
| Nonyl phenol polyglycol ether | 5%; |
| Urea | 5%; |
| Xanthan gum | 0.2%; |
| Sodium benzoate | 0.3%; |
| Magnesium aluminum silicate | 1%; |
| Silica | 1%; |

Top up with water to 100%;

Add all the components into a grinder and ground to obtain suspension concentrate.

### Embodiment 4

25% compound I (tetrahydrobenzazole) emulsifiable concentrate:

| | |
|---|---|
| Compound I | 25%; |
| Emulsifier 50 | 56%; |
| Emulsifier 601 | 5%; |
| Cyclohexanone | 20%; |
| Dimethyl sulfoxide | 10%; |
| NP-20 | 2%; |

Top up with solvent oil S-150 to 100%;

Add all the components into a reactor and stir, dissolve and mix them well to obtain emulsifiable concentrate.

### Embodiment 5

Determination of in vitro fungicidal activity:

Use an inoculating needle to pick a small culture medium block containing target bacteria from a test strain tube in a super clean bench by the growth rate method, put it in a large culture dish containing PDA culture medium, quickly cover the culture dish, seal it tightly with a seal, and culture it in an incubator. Perforate with a sampler with an inner diameter of 0.70 cm after the colonies of the test bacteria are evenly distributed in the culture dish to obtain fungus cakes with a diameter of 0.70 cm. Add 1 mL of test drug solution to a Φ10 cm culture dish, then add 9 mL (temperature 85˜90° C.) of culture medium, shake them up in a super clean bench and spread over into a uniform plane. Determine in vitro fungicidal activity of compound I at concentrations of 10 μg/mL, 5 μg/mL, 10 μg/mL, 15 μg/mL and 20 μg/mL against more than 20 kinds of common pathogens of crops such as Botrytis cinerea Pers. Culture the culture dish in a 28° C. constant temperature incubator, check the result according to the extension status of target colonies and determine colony diameter extended from each fungus cake at an appropriate time by the cross method. Calculate an inhibition ratio according to the colony extension diameter and the diameter of the blank control.

Inhibition ratio of mycelial growth (%)=[(diameter of the control colony−diameter of the colony treated with a drug)/diameter of the control colony]×100%.

The effect of fungicidal activity of structural formula I is shown in Table 1.

TABLE 1
Fungicidal activity (inhibition ratio %) of Formula I:

| Pathogen | | | | Compound concentration (μg/mL) | | | | |
|---|---|---|---|---|---|---|---|---|
| 1 | Pathogen | Subphylum | Plant disease | 1 | 5 | 10 | 15 | 20 |
| 2 | Botrytis cinerea | Fungi imperfecti | Cucumber gray mold | — | — | 5.10 | 9.98 | 21.26 |
| 3 | Altemaria solani | | Tomato early blight | 13.20 | 52.88 | 67.29 | 77.88 | 85.86 |
| 4 | Cercospora arachidicola | | Peanut brown spot | — | 19.71 | 31.25 | 39.48 | 56.68 |
| 5 | Botrytis cinerea | | Strawberry grey mold | — | — | 7.12 | 13.46 | 29.22 |
| 6 | Alternaria kikuchiana | | Pear black spot | 29.98 | 35.76 | 46.61 | 59.78 | 67.44 |
| 7 | Fusarium oxysporum f. sp cucumerinum | | Cucumber fusarium wilt | — | — | 18.32 | 31.77 | 48.18 |
| 8 | Rhizoctonia solani | | Rice sheath blight | 37.80 | 52.79 | 68.48 | 72.82 | 82.56 |
| 9 | Pyricularia grisea | | Rice blast | 11.94 | 25.37 | 44.73 | 58.23 | 67.59 |
| 10 | Acinomycete spiculata | | Cucumber anthrax | 37.85 | 41.18 | 53.51 | 58.17 | 65.73 |
| 11 | Fusarium moniliforme | | Rice bakanae disease | — | 22.26 | 36.71 | 45.62 | 61.79 |
| 12 | Helminthosporium carposaprum | | Corn spot | 8.92 | 22.44 | 33.45 | 44.46 | 53.22 |
| 13 | Acanthopteris fungi | | Colletotrichum capsici | 28.70 | 47.29 | 53.59 | 68.32 | 78.96 |
| 14 | Alternaria alternata (Fr.) Keissl | | Apple altermaria leaf spot | 26.94 | 34.48 | 52.31 | 66.71 | 74.65 |
| 15 | Sclerotinia sclerotiorum | Ascomycotina | Chili sclerotium | 12.81 | 17.96 | 25.35 | 39.34 | 55.18 |
| 16 | Mycosphaerella musicola | | Banana leaf spot disease | 25.26 | 31.30 | 43.35 | 52.11 | 66.76 |
| 17 | Sinoe ampelina (de Bary) Shear | | Grape anthracnose | — | 25.12 | 42.04 | 52.93 | 65.18 |
| 18 | Botryosphaeria | | Apple ring spot | — | 41.28 | 53.56 | 68.76 | 73.46 |
| 19 | Sphaerotheca fuliginea (Schlecht) Poll. | | Cucumber powdery mildew | 38.70 | 57.29 | 63.59 | 78.32 | 88.96 |
| 20 | Sclerotinia sclerotiorum | | Cucumber sclerotinia rot | 12.55 | 34.23 | 51.21 | 64.29 | 71.84 |
| 21 | Phytophthora | Flagellate | Potato late blight | 27.03 | 31.96 | 43.44 | 65.08 | 73.63 |
| 22 | Erysiphe | Erysiphe | Strawberry powdery mildew | 33.24 | 54.62 | 67.26 | 76.09 | 79.02 |

“—” means the activity is not obvious.

Table 1 indicates that compound in Formula I shows a desirable activity in inhibition to most of the test pathogens, suggesting that this compound has a large value of development and utilization.

### Embodiment 6

Field efficacy experiment of fungicidal composition in Formula I on prevention and treatment of strawberry powdery mildew:

The experimental drugs are the drugs prepared in Embodiments 2, 3 and 4. The control groups are 10% difenoconazole water dispersible granules (commercial Shigao), and 30% triflumizole water dispersible granules (commercial Trifmine). The experiment is for observing the effects of the fungicidal composition in Formula I on prevention and treatment of strawberry powdery mildew in the field.

The field experiment was completed in a greenhouse. The cultivation and management are consistent with those of strawberry in the hilly areas of Jiangsu Province. The soil type of the experimental land is yellow soil.

Before application of drugs, the situation of strawberry powdery mildew was investigated. Drugs were applied at the first time at the initial stage of the disease and once every seven days, three times in total. 7, 14 and 21 days after the first application, the disease index of strawberry powdery mildew was investigated respectively and the preventive effect was calculated.

The results are as shown in Table 2.

TABLE 2
Efficacy experiment of a fungicidal composition
containing structural formula I on prevention
and control of strawberry powdery mildew:

| | | 7 D after | 14 D after | 21 D after |
|---|---|---|---|---|
| | | the first | the second | the last |
| | | application | application | application |
| | Dose | Preventive | Preventive | Preventive |
| Treatment drug | (g/mu) | effect (%) | effect (%) | effect (%) |
| 10% Formula I | 60 | 67.20 | 75.37 | 77.36 |
| water dispersible | | | | |
| granules | | | | |
| 30% Formula I | 30 | 51.37 | 68.63 | 76.12 |
| suspension | | | | |
| concentrate | | | | |
| 25% Formula I | 30 | 55.96 | 67.88 | 74.64 |
| emulsifiable | | | | |
| concentrate | | | | |
| 10% difenoconazole | 60 | 62.07 | 69.12 | 71.73 |
| water dispersible | | | | |
| granules | | | | |
| 30% triflumizole | 30 | 48.17 | 68.45 | 58.46 |
| water dispersible | | | | |
| granules | | | | |

Table 2 indicates that the fungicidal composition in Formula I can effectively prevent and control strawberry powdery mildew, is superior to the control drugs in terms of prevention and treatment effects and has a long effect. In the range of experimental doses, the fungicidal composition does not have an ill effect on the target crops and the preventive effect is above 75%.

### Embodiment 7

Field efficacy experiment of fungicidal composition in Formula I on prevention and treatment of rice sheath blight disease:

The experimental drugs are the drugs prepared in Embodiments 2, 3 and 4. The control groups are 40% difenoconazole suspension concentrate (commercial Runcai) and 75% trifloxystrobin⋅tebuconazole water dispersible granules (commercial WG). The experiment is for observing the effects of the fungicidal composition in Formula I on prevention and treatment of rice sheath blight disease in the field.

The field experiment was conducted in a late paddy field at Dating Village, Jincheng Town, Jintan District, Changzhou City. The area of the demonstration field is 1600.8 m². The soil fertility is moderate, the irrigation and drainage are convenient, and paddy was planted every year in the past. The test paddy variety is Wu Xiang Jing 14. Sowing was conducted on May 17, 2016 and transplanting was conducted on Jun. 15, 2016. In the experimental period, no other fungicides were sprayed in the demonstration plots, and the soil, growth, planting and fertilizer and water conditions of the plots were substantially consistent and tallied with the actual conditions of local agricultural production. Before application, the situation of rice sheath blight disease was investigated, the first application of drugs was on the morning of August 22, and 10 days later (September 2), the drugs were applied again. It was clear on the two days of application. 24 h after the application, it did not rain. The drugs were applied for two times in total. 10 and 20 days after the first application, the disease index of rice sheath blight disease was investigated respectively and the preventive effect was calculated.

The results are as shown in Table 3.

TABLE 3
Efficacy experiment of a fungicidal composition containing structural
formula I on prevention and control of rice sheath blight disease:

| | | 10 D after | 20 D after |
|---|---|---|---|
| | | the first | the first |
| | | application | application |
| | Dose | Preventive | Preventive |
| Treatment drug | (g/mu) | effect (%) | effect (%) |
| 10% Formula I water | 60 | 57.37 | 70.16 |
| dispersible granules | | | |
| 30% Formula I suspension | 40 | 68.63 | 76.33 |
| concentrate | | | |
| 25% Formula I emulsifiable | 40 | 66.64 | 73.96 |
| concentrate | | | |
| 40% difenoconazole | 30 | 72.24 | 72.30 |
| suspension concentrate | | | |
| 75% trifloxystrobin•tebuconazole | 20 | 73.42 | 81.42 |
| water dispersible granules | | | |

Table 3 indicates that the fungicidal composition in Formula I can effectively prevent and control rice sheath blight disease, is equivalent to the control drugs in terms of prevention and treatment effects and has a long effect. In the range of experimental doses, the fungicidal composition does not have an ill effect on the target crops and the preventive effect is above 70%.

In this document, meaning of industrial materials should be understood as manufactured non-live materials to be used in the industry. For example, the industrial materials that are intended to be protected by the active compound of embodiments of the present invention from microbiological modification or destruction can be glue, sizing material, paper and paperboard, textile, leather, timber, coating and plastic products, cooling lubricant and other materials that can be invaded or damaged by microorganisms. The production equipment components that may be damaged by reproduction of microorganisms, such as cooling water pipelines, are also mentionable materials to be protected. The industrial materials that can be preferably mentioned for the purpose of embodiments of the present invention are glue, sizing material, paper and paperboard, textile, leather, timber, coating, cooling lubricant and heat transfer fluid, preferably timber.

The mentionable microorganisms that can degrade or denature industrial materials are for example bacteria, fungi, yeast, algae and mucous organisms. The active compound of embodiments of the present invention is preferably active to fungi, particularly mold, wood fading fungi and Phellinusribis (basidiomycetes), as well as mucous organisms and algae.

Embodiment 8 is substantially the same as the foregoing embodiment, but in the preparation process, a dose of nitric acid at the first time is 1˜2 times of the mole number of tetrahydrobenzazole in difenoconazole waste, preferably 1˜1.2 times; mass concentration of nitric acid is 65˜100%, preferably 95˜98%; a dose of nitric acid at the second time is 1˜2 times of the mole number of difenoconazole in difenoconazole waste, preferably 1˜1.2 times; mass concentration of nitric acid is 65˜100%, preferably 95˜98%; the alkali typically is sodium hydroxide (m/m30% caustic soda liquid), potassium hydroxide, sodium carbonate, potassium carbonate, etc., preferably m/m30% caustic soda liquid; a dose is 1˜2 times of the mole number of difenoconazole nitrate, typically 1.1 times; appropriate decomposition temperature is 10˜70° C., typically 60˜70° C.; a dose of toluene is 1˜10 times of the weight of difenoconazole waste, preferably 3˜4 times; the alkali typically is sodium hydroxide (m/m30% caustic soda liquid), potassium hydroxide, sodium carbonate, potassium carbonate, etc., preferably 30% caustic soda liquid; a dose is 1˜2 times, typically 1˜1.1 times of the mole number of difenoconazole nitrate; appropriate decomposition temperature is 10˜70° C., typically 60˜70° C. A dose is 100 g of the compound per hectare.

Embodiment 9 is substantially the same as the foregoing embodiment, but in the preparation process, a dose of nitric acid at the first time is 1 time of the mole number of tetrahydrobenzazole in difenoconazole waste; mass concentration of nitric acid is 65%; a dose of nitric acid at the second time is 1 time of the mole number of difenoconazole in difenoconazole waste; mass concentration of nitric acid is 65%; the alkali is sodium hydroxide (m/m30% caustic soda liquid); a dose is 1 time of the mole number of difenoconazole nitrate; appropriate decomposition temperature is 10° C.; a dose of toluene is 1 time of the weight of difenoconazole waste; the alkali is sodium hydroxide (m/m30% caustic soda liquid); a dose is 1 time of the mole number of difenoconazole nitrate; appropriate decomposition temperature is 10˜70° C. A dose is 5 g of the compound per hectare.

Embodiment 10 is substantially the same as the foregoing embodiment, but in the preparation process, a dose of nitric acid at the first time is 2 times of the mole number of tetrahydrobenzazole in difenoconazole waste; mass concentration of nitric acid is 100%; a dose of nitric acid at the second time is 2 times of the mole number of difenoconazole in difenoconazole waste; mass concentration of nitric acid is 100%; the alkali is potassium hydroxide; a dose is 2 times of the mole number of difenoconazole nitrate; appropriate decomposition temperature is 70° C.; a dose of toluene is 10 times of the weight of difenoconazole waste; the alkali is potassium hydroxide; a dose is 2 times of the mole number of difenoconazole nitrate; appropriate decomposition temperature is 60˜70° C. A dose is 500 g of the compound per hectare.

Embodiment 11 is substantially the same as the foregoing embodiment, but in the preparation process, a dose of nitric acid at the first time is 1.2 times of the mole number of tetrahydrobenzazole in difenoconazole waste; mass concentration of nitric acid is 95%; a dose of nitric acid at the second time is 1.2 times of the mole number of difenoconazole in difenoconazole waste; mass concentration of nitric acid is 95%; the alkali is sodium carbonate; a dose is 1.1 times of the mole number of difenoconazole nitrate; appropriate decomposition temperature is 60˜70° C.; a dose of toluene is 3˜4 times of the weight of difenoconazole waste; the alkali is potassium carbonate; a dose is 1.1 times of the mole number of difenoconazole nitrate; appropriate decomposition temperature is 60˜70° C. A dose is 300 g of the compound per hectare.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1-10. (canceled)

11. An application of 4-((-(2-chloro-4-(4-chlorophenoxy) phenyl)-4-methyl-1,3-dioxapentan-2-yl) methyl)-4H-1,2,4-triazole (tetrahydrobenzazole) compound in agricultural fungicide, with a structural formula as shown in Formula I:

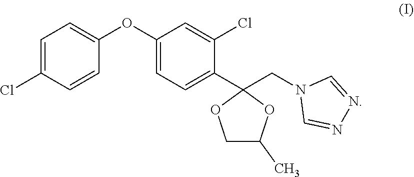 [SMILES: CC1COC(Cn2cnnc2)(c2ccc(Oc3ccc(Cl)cc3)cc2Cl)O1]

12. The application of 4-((-(2-chloro-4-(4-chlorophenoxy) phenyl)-4-methyl-1,3-dioxapentan-2-yl) methyl)-4H-1,2,4-triazole (tetrahydrobenzazole) compound in agricultural fungicide according to claim 11, wherein the application is for preventing and treating various diseases caused by Ascomycetes, Basidimycetes, fungi imperfecti including Alternaria, Ascochyta, Cercospora, Colletotrichum, Guignardia, Phoma, Ramularia and Venturia, Erysiphe, Uredinales and some pathogens.

13. The application of 4-((-(2-chloro-4-(4-chlorophenoxy) phenyl)-4-methyl-1,3-dioxapentan-2-yl) methyl)-4H-1,2,4-triazole (tetrahydrobenzazole) compound in agricultural fungicide according to claim 11, wherein a dose is 5˜500 grams of the compound per hectare.

14. The application of 4-((-(2-chloro-4-(4-chlorophenoxy) phenyl)-4-methyl-1,3-dioxapentan-2-yl) methyl)-4H-1,2,4-triazole (tetrahydrobenzazole) compound in agricultural fungicide according to claim 11, wherein the application is a fungicide composition containing 4-((-(2-chloro-4-(4-chlorophenoxy) phenyl)-4-methyl-1,3-dioxapentan-2-yl) methyl-4H-1,2,4-triazole (tetrahydrobenzazole) compound in Formula I as an active ingredient and agriculturally acceptable carriers, with the weight percentage of the active ingredient being 1%˜99%.

15. The application of 4-((-(2-chloro-4-(4-chlorophenoxy) phenyl)-4-methyl-1,3-dioxapentan-2-yl) methyl)-4H-1,2,4-triazole (tetrahydrobenzazole) compound in agricultural fungicide according to claim 12, wherein the application is a fungicide composition containing 4-((-(2-chloro-4-(4-chlorophenoxy) phenyl)-4-methyl-1,3-dioxapentan-2-yl) methyl-4H-1,2,4-triazole (tetrahydrobenzazole) compound in Formula I as an active ingredient and agriculturally acceptable carriers, with the weight percentage of the active ingredient being 1%˜99%.

16. The application of 4-((-(2-chloro-4-(4-chlorophenoxy) phenyl)-4-methyl-1,3-dioxapentan-2-yl) methyl)-4H-1,2,4-triazole (tetrahydrobenzazole) compound in agricultural fungicide according to claim 13, wherein the application is a fungicide composition containing 4-((-(2-chloro-4-(4-chlorophenoxy) phenyl)-4-methyl-1,3-dioxapentan-2-yl) methyl-4H-1,2,4-triazole (tetrahydrobenzazole) compound in Formula I as an active ingredient and agriculturally acceptable carriers, with the weight percentage of the active ingredient being 1%˜99%.

17. The application of 4-((-(2-chloro-4-(4-chlorophenoxy) phenyl)-4-methyl-1,3-dioxapentan-2-yl) methyl)-4H-1,2,4-triazole (tetrahydrobenzazole) compound in agricultural fungicide according to claim 14, wherein the application is to mix the compound with one or more other fungicides, insecticides, herbicides or plant growth regulators to form a binary or ternary mixed formulation.

18. The application of 4-((-(2-chloro-4-(4-chlorophenoxy) phenyl)-4-methyl-1,3-dioxapentan-2-yl) methyl)-4H-1,2,4-triazole (tetrahydrobenzazole) compound in agricultural fungicide according to claim 15, wherein the fungicide composition is a liquid or solid in a use form is granule, suspension concentrate or emulsifiable concentrate; and a dose is 100-300 grams of the compound per hectare.

19. The application of 4-((-(2-chloro-4-(4-chlorophenoxy) phenyl)-4-methyl-1,3-dioxapentan-2-yl) methyl)-4H-1,2,4-triazole (tetrahydrobenzazole) compound in agricultural fungicide according to claim 16, wherein
preparation of the granules: mix the active ingredient, various surface active agents, solid diluents and other components as per requirements of the formula, pulverize them in an ultrafine grinder, and extrude and pelletize the powder to obtain a granular product with a predetermined content 10%˜80%;
preparation of the suspension concentrate: in a commonly used formula, the content of the active ingredient is 10%˜40%, water or white wax is used as a medium, and the active ingredient, dispersing agent, suspending agent and antifreezing agent are added into a grinder and ground to obtain suspension concentrate; and
preparation of the emulsifiable concentrate: add the active ingredient, surface active agents and solvent into a preparation kettle as per requirements of the formula and stir and mix them well to obtain an emulsifiable concentrate product.

20. A method for preparing 4-((-(2-chloro-4-(4-chlorophenoxy) phenyl-4-methyl-1,3-dioxapentan-2-yl) methyl)-4H-1,2,4-triazole (tetrahydrobenzazole) compound, comprising the following steps:
(1). adding difenoconazole waste into a reactor and dissolve the difenoconazole waste in a solvent;
(2). salifying dissolved difenoconazole with an acid at appropriate temperature and crystallizing upon cooling;
(3). performing filtration and separation at appropriate temperature to obtain tetrahydrobenzazole salt;
(4). adding separated filtrate into the reactor again, salifying dissolved difenoconazole with an acid again and crystallizing upon cooling;
(5). performing filtration and separation to obtain tetrahydrobenzazole salt, recovering the solvent from the separated filtrate through treatment and distillation for use, and disposing residue after distillation as a solid waste;
(6). adding difenoconazole salt obtained at step (5) into the reactor, adding an appropriate amount of toluene and water, decomposing in alkali at appropriate temperature, and resting for layering;
(7). separating the water phase in the lower layer, washing the toluene phase in the upper layer with water until the toluene phase is neutral and thoroughly removing water;
(8). conducting reduced pressure distillation to recover toluene for reuse, with remnant being difenoconazole crude oil;
(9). obtaining difenoconazole technical through further refinement;
(10). adding tetrahydrobenzazole salt obtained at step (3) into a reactor, adding a specific amount of toluene and water, decomposing in alkali at specified temperature and resting for phase split;
(11). separating the water phase in the lower layer, washing the toluene phase in the upper layer with water until it is neutral and thoroughly removing water;
(12). conducting reduced pressure distillation to recover toluene for reuse, with remnant being difenoconazole crude oil; and
(13). adding tetrahydrobenzazole crude oil obtained at step (12) to a refining reactor, adding an equal amount of toluene, raising temperature for dissolution, cooling and crystallizing under stirring, then performing filtration and separation to obtain tetrahydrobenzazole technical in Formula (1), distilling the filtrate after filtration and separation to recover toluene for reuse, and disposing remnant in a centralized manner.

21. The method for preparing 4-((-(2-chloro-4-(4-chlorophenoxy) phenyl)-4-methyl-1,3-dioxapentan-2-yl) methyl)-4H-1,2,4-triazole (tetrahydrobenzazole) compound according to claim 20, wherein,
at step (1), the solvent is alkanes, arenes, alcohols or ethers; a dose of the solvent is 1˜10 times of the weight of difenoconazole waste;
appropriate temperature at step (2) is 10˜60° C.; the acid is hydrochloric acid (including hydrogen chloride gas), nitric acid, sulfuric acid and hydrogen bromide; a dose of nitric acid is 1˜2 times of the mole number of tetrahydrobenzazole in difenoconazole waste;
mass concentration of nitric acid is 65˜100%;
appropriate temperature for filtration and separation at step (3) is 0˜25° C.;
the acid at step (4) is hydrochloric acid (including hydrogen chloride gas), nitric acid, sulfuric acid and hydrogen bromide; a dose of nitric acid is 1˜2 times of the mole number of difenoconazole in difenoconazole waste; mass concentration of nitric acid is 65˜100%;
the amount of toluene at step (6) is 1˜10 times of the weight of difenoconazole nitrate; the alkali is sodium hydroxide (m/m30% caustic soda liquid), potassium hydroxide, sodium carbonate, potassium carbonate or ammonium hydroxide; the amount is 1˜2 times of the mole number of difenoconazole nitrate; appropriate decomposition temperature is 10˜70° C.;
the amount of toluene at step (10) is 1˜10 times of the weight of tetrahydrobenzazole nitrate; the alkali is sodium hydroxide (m/m30% caustic soda liquid), potassium hydroxide, sodium carbonate, potassium carbonate or ammonium hydroxide; the amount is 1˜2 times of the mole number of tetrahydrobenzazole nitrate; specified decomposition temperature is 10˜70° C.

22. The method for preparing 4-((-(2-chloro-4-(4-chlorophenoxy) phenyl)-4-methyl-1,3-dioxapentan-2-yl) methyl)-4H-1,2,4-triazole (tetrahydrobenzazole) compound according to claim 21, wherein,
at step (1), a dose of the solvent is 3˜4 times of the weight of difenoconazole waste;
at step (1), the alkane is hexane or cyclohexane, the arene is benzene or xylene, the alcohol is methanol, ethanol, propanol or isopropanol, and the ether is diethyl ether, isopropyl ether or methyl tert-butyl ether; and the dose of the solvent is 1˜10 times of the weight of difenoconazole waste;
at step (2), appropriate temperature is 20˜40° C.; the acid is nitric acid; a dose of nitric acid is 1˜1.2 times of the mole number of tetrahydrobenzazole in difenoconazole waste; mass concentration of nitric acid is 95˜98%;
at step (3), appropriate temperature for filtration and separation is 15˜18° C.;
at step (4), the acid is nitric acid; the dose of nitric acid is 1˜1.2 times of the mole number of difenoconazole in difenoconazole waste; mass concentration of nitric acid is 95˜98%;
at step (6), the amount of toluene is 3˜4 times of the weight of difenoconazole nitrate; the alkali is 30% sodium hydroxide water solution; the amount is 1˜1.1 times of the mole number of difenoconazole nitrate;
at step (10), the amount of toluene is 3˜4 times of the weight of tetrahydrobenzazole nitrate; the alkali is 30% sodium hydroxide water solution; the amount is 1˜1.1 times of the mole number of difenoconazole nitrate.
